(19) United States
(12) Patent Application Publication
(10) Pub. No.: US 2007/0185758 A1
(43) Pub. Date: Aug. 9, 2007

(54) BUSINESS METHOD FOR TRANSITIONING GRANT AND/OR DONATION DEPENDENT ORGANIZATIONS TO SELF-SUFFICIENT ENTERPRISES

(75) Inventors: Mary Margaret Gibson, Little Elm, TX (US); Robert L. Nance Jr., Fort Wayne, IN (US)

Correspondence Address: BAKER & DANIELS LLP;111 E. WAYNE STREET, SUITE 800, FORT WAYNE, IN, 46802, US

(73) Assignee: INSTITUTE FOR CHORAL PROFESSIONALS, Fort Wayne, IN (US)

(21) Appl. No.: 11/622,638

(22) Filed: Jan. 12, 2007

Related U.S. Application Data
(60) Provisional application No. 60/758,326, filed on Jan. 12, 2006.

(51) Int. Cl. G07G 1/00; G06F 17/30

(52) U.S. Cl. 705/10

(57) ABSTRACT

A business method or design created specifically to transition cultural and community services organizations from grant and donation-dependent Title 26, U.S.C. §501(c)(3) organizations to self-sufficient enterprises. In an exemplary method, the business method or design transitions a plurality of grant and/or donation-dependent organizations to self-sufficient enterprises by determining a group of grant and/or donation-dependent organizations in a substantially common field; selecting a model organization from the group; developing an Incubator business for transitioning the model organization; transitioning the model organization, using the Incubator business, to a self-sufficient enterprise; transitioning at least one other organization in the group, using the Incubator business, to a self-sufficient enterprise.

### CROSS-REFERENCE TO RELATED APPLICATIONS

This application claims the benefit under Title 35, U.S.C. §119(e) of U.S. Provisional Patent Application Ser. No. 60/758,326, entitled Business Method for Transitioning a Plurality of Grant and/or Donation Dependent Organizations to Self-Sufficient Enterprises, filed on Jan. 12, 2006, the disclosure of which is expressly incorporated herein by reference.

### BACKGROUND OF THE INVENTION

1. Field of the Invention.

The present invention relates to a business method or business design for transitioning grant and/or donation-dependent organizations, such as Title 26, U.S.C. §501(c)(3) organizations, to self-sufficient enterprises.

2. Description of the Related Art.

In the last 5 years, the percentage of funding available for cultural and community services organizations has declined steadily each year. After peaking in 2001, each year that followed has shown a decline in funding levels. Median arts grants have remained at $25,000 per program, according to The Foundation Center, hardly the scale required to match the costs of operating cultural organizations such as museums, choruses, symphonies, drama troupes and ballet companies. Funding for arts and cultural organizations now ranks 5^{th} in the Foundation Center's list of priorities for foundation funding behind emergency, relief, health, and education.

In a recent Wall Street Journal article (Oct. 8-9, 2005, p. P11) by Douglas McLennan entitled “Culture Clash” the following question is raised: “Has the business model for arts institutions outlived its usefulness?” One of the comments in this article states “Going forward, while donated income might increase incrementally, it can't grow by the magnitude needed to support new overbuilt levels of arts activity” and “earned income plays a significant role in nonprofits' operations.” “Even stretching traditional non-profit status to the point of breaking, the current [business] model looks unsustainable, both financially and artistically.”

What is needed is a business method or business design created specifically for transitioning grant and/or donation-dependent organizations, such as Title 26, U.S.C. §501(c)(3) organizations, to self-sufficient enterprises.

### SUMMARY OF THE INVENTION

The present invention provides a business method or business design created specifically to transition cultural and community services organizations from grant and/or donation-dependent organizations to self-sufficient enterprises. The present method or business design is the first and only business method or design specifically created to launch and sustain the conversion of donation-dependent organizations, such as Title 26, U.S.C. §501(c)(3) (“501(c)(3)”) organizations, for example, to independent, self-sufficient organizations. The present method or business design is adaptable and flexible so that implementation thereof can be used to transition many different types of donation-dependent organizations to self-sufficiency.

In one exemplary application, the present method or business design combines five hitherto unlinked business development components into a company whose role is to re-develop cultural and community services organizations. In particular, the present method utilizes the development of a best transition model (“Model”), such as a selected donation-dependent organization, to create specialized Transition Services to transition all organizations of the same type as the Model. For example, one application of present method is to create self-sufficient, paid professional symphony orchestras or choruses from organizations previously staffed by volunteers and funded primarily from donations and grants.

The present method provides the specialized services and focus to change the orientation, management, marketing, funding, and priorities of organizations transitioning from donation-dependency to self-sufficiency.

Examples of the types of organizations for which the present method can be used to transition such organizations to self-sufficiency include: arts organizations such as museums, arts education organizations, and artist cooperatives; music organizations such as regional and city symphony orchestras, and choruses; community medical clinics, rehabilitation clinics, and preventive care clinics; food banks, emergency relief organizations, and specialty care organizations (battered women and children, indigent and homeless shelters, neighborhood revitalization); and zoos and nature preservation organizations.

Advantageously, the present business method or design meets the test of business effectiveness by providing all the necessary know-how and services to properly transition 501c)(3) organizations to profit-making enterprises in a single business design and further, meets the test of business efficiency by quickly delivering the results of rapid business transition and providing levels of return on investment more than sufficient to attract and retain accredited investors who will invest at levels appropriate to the transition of even the largest 501(c)(3) organizations.

In one form thereof, the present invention provides a method of transitioning a plurality of grant and/or donation-dependent organizations to self-sufficient enterprises, including the steps of determining a group of grant and/or donation-dependent organizations in a substantially common field; selecting a model organization from the group; developing an Incubator business for transitioning the model organization; transitioning the model organization, using the Incubator business, to a self-sufficient enterprise; transitioning at least one other organization in the group, using the Incubator business, to a self-sufficient enterprise.

### BRIEF DESCRIPTION OF THE DRAWINGS

The above-mentioned and other features and advantages of the present invention, and the manner of attaining them, will become more apparent and the invention itself will be better understood by reference to the following description of the present invention with the accompanying drawings, wherein:

FIG. 1 illustrates the present method and its relationship to transitioning organizations;

FIG. 2 presents an overview of exemplary steps used in accordance with the present method;

FIGS. 3a and 3b present exemplary steps in transitioning a model organization;

FIG. 4 illustrates application of the present method to a model organization which is a 501(c)(3) chorus;

FIG. 5 illustrates application of the present method to a model organization which is a 501(c)(3) community medical clinic;

FIG. 6 illustrates application of the present method to a model organization which is a 501(c)(3) literacy program provider; and

FIG. 7 illustrates application of the present method to a model organization which is a 501(c)(3) regional symphony.

The exemplifications set out herein illustrate preferred embodiments of the invention, and such exemplifications are not to be construed as limiting the scope of the invention in any manner.

### DETAILED DESCRIPTION

The present invention relates to a business method or business design created specifically to transition cultural and community services organizations from grant and donation-dependent Title 26, U.S.C. §501(c)(3) (“501(c)(3)”) organizations to self-sufficient enterprises. As used herein, a “self-sufficient” organization is an organization in which the income from related products and services sustains the operations of the organization so it can complete its primary functions without funds, or with limited funds, from donors.

In the following discussion and in the Figures, the present business method or design is generally referred to as “The Wrap-Around Incubator”.

Examples of the types of organizations for which The Wrap-Around Incubator can be used to transition to self-sufficiency include: arts organizations such as museums, arts education organizations, and artist cooperatives; music organizations such as regional and city symphony orchestras, and choruses; community medical clinics, rehabilitation clinics, and preventive care clinics; food banks, emergency relief organizations, and specialty care organizations (battered women and children, indigent and homeless shelters, neighborhood revitalization); and zoos and nature preservation organizations.

I. Overview of the Wrap-Around Incubator.

In one exemplary application, The Wrap-Around Incubator utilizes the development of a Best Transition Model (“Model”), such as a selected donation-dependent organization, to create specialized Transition Services to transition all organizations of the same type as the Model. For example, one application of The Wrap-Around Incubator is to create self-sufficient, paid professional symphony orchestras or choruses from organizations previously staffed by volunteers and funded primarily from donations and grants.

This innovative method of transitioning a Model organization is needed because traditional 501(c)(3) organizations have become so immersed in the donor-related approach to funding that lacking the best practices achieved in Model transition, they must use slow trial-and-error methods of changing and transitioning their organizations. Many have capital trapped in aging facilities or cumbersome infrastructure. The value of best practices developed specifically for their operation type is that the capital can often be unlocked and converted to cash, new products and services can be created, and dependency reduced, leveraging the lessons learned in transitioning the Model.

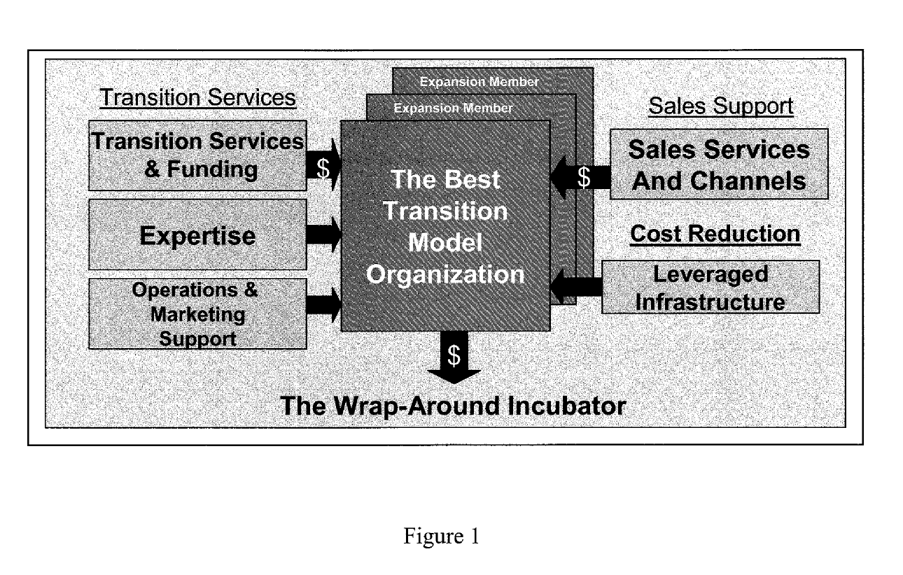

As discussed in detail below, The Wrap-Around Incubator transitions the Model organization toward self-sufficiency in real time, while developing tools and techniques useful to organizations which follow the path set by the Model and the Incubator. FIG. 1 shows exemplary services developed by the Incubator staff for the Model and then purchased by the Model. These services are later provided to additional organizations of the same type as the Model. Infrastructure developed by the Incubator serves both the Model and additional organizations of the same type.

The Model transition thus becomes the service development “factory” for a variety of services specific to the organization type. All the elements of an independent venture may be addressed: Product Development, Marketing, Sales, Operations, Finance, HR, Facilities, and Purchasing. The Wrap-Around Incubator productizes the knowledge, know-how, and practices used to successfully transition the Model to self-sufficiency.

In some cases, the transition may take place in less than two years. In other cases, such as where an organization is heavily dependent on donor funding, has few profitable products, and/or has much of its capital locked in facilities, the transition may require more time and effort. The approach is unique and supportive—the most likely-to-succeed model—because all the parties stand to gain and gain substantively.

The Wrap-Around Incubator can be used to transition any type of 501(c)(3) organization, particularly if the unique products, services, mission, and cultural characteristics of the Model are identified and a business constructed around the model to support each of those elements.

The Model becomes self-sufficient generating its own income, additional organizations become self-sufficient creating value and income, and investors in the Incubator make significant return as products and services are widely used by all the transitioning organizations.

Money flows from a Transitioning Organization (TO) to the Incubator may occur as the Incubator provides services and other benefits to the TO which speed transition in return for rents, commissions, subscription fees, and consulting fees. Revenue may flow from a single TO to the Incubator, or as all TO's of a particular type may use similar services, revenue may also flow to the Incubator from many TO clients. The percentage of revenue resulting from each category of fees, interest, rent, and commissions varies by the type of organizations being transitioned. The Incubator tailors its services and funding appropriately to meet the demands of the Model, and thus the subsequent TO's of the same type.

The Wrap-Around Incubator may be applied to a single, multi-faceted cultural, or community services organization. A single Model-centric application creates the best return for investors when a large, diversified organization is selected for transition, e.g. a major museum, symphony, opera, or medical services organization. The implementation of the Incubator for a single Model-centric application differs primarily in the methods by which capital is converted to cash, and the methods by which the Model's services and products are sold. All the principles of The Wrap-Around Incubator may be implemented in this single Model-centric application, and the same tests of business efficiency, effectiveness, and investor return are met.

The services provided by The Wrap-Around Incubator, especially the marketing and sales services, are similar to services that the Model organization might outsource on its own, if it could source the services specifically designed for its needs, so paying fees for those services is a realistic expense for the Transitioning Organization (TO) to pay.

Speed of transition is an important advantage of The Wrap-Around Incubator, since the transition of the Model provides a roadmap for the successful transition of other similar organizations.

The Wrap-Around Incubator is a business design so flexible that it can be established as a Limited Liability Company (LLC), a LLP (Limited Liability Partnership), or a C Corporation. The LLC is preferred because of its (1) flexibility in the number and size of investments allowed, and (2) tax treatment of donations and losses which pass through to investors during early stage development, and (3) a single level of taxation.

The Wrap-Around Incubator addresses all the elements of business in transitioning donation-dependent organizations (TO) to self-sufficiency.

Due to the current tax treatment of 501(c)(3) organizations, the Incubator may operate within the realm of the exempt activities for which organizations of a specific type have been chartered. Thus, a new Incubator may be formed for each unique type of organization. The same Wrap-Around Incubator may not be suitable, for example, transition choruses and community clinics. The requirements of each type of operation and management would require different services, product development, financing levels, facilities, and staff.

II. Description of an Exemplary Method for Creating a Wrap-Around Incubator and Transitioning Donation-Dependent Organizations to Self-Sufficiency.

Operators considering the creation of a Wrap-Around Incubator to transition organizations of a specific type may follow the Method outlined below. Each step may be linked to the previous and following step. Additional steps may be added for unique organizational types, as described below. In the process of creating self-sufficient organizations, investors and operators of the Wrap-Around Incubator may make handsome profits over time. They may engage in businesses as diverse as real estate, medicine, music, arts organization development, and even in the effective running of zoos and other unusual facilities. The method for creating the Wrap-Around Incubator can be rigorous in its evaluation of the market for its services, so that the Incubator investors will most likely receive market rates of return.

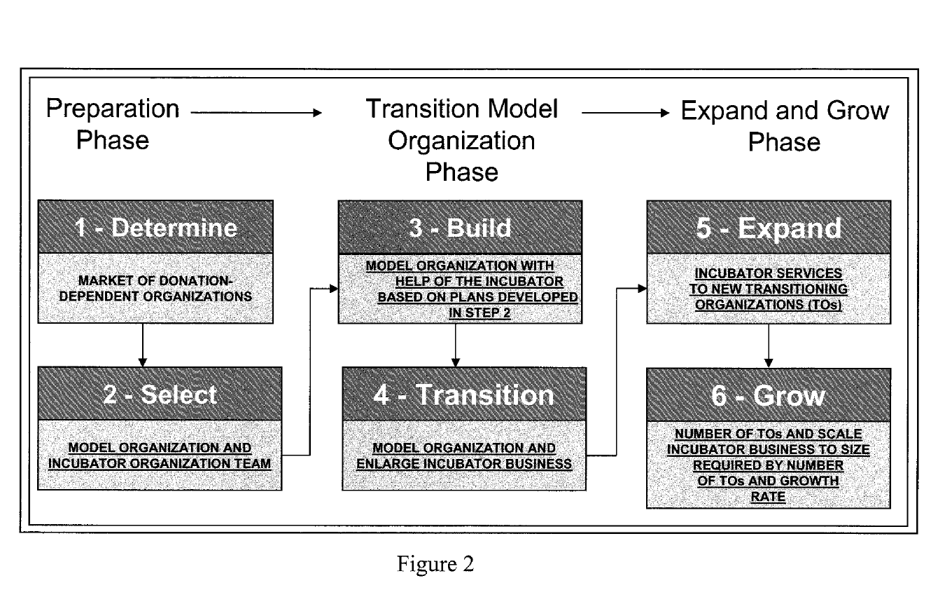

A detailed flow chart of an exemplary methodology is shown in FIG. 2, which illustrates steps and details of the methodology for creating a Wrap-Around Incubator and using it to transition multiple organizations to self-sufficiency.

The Wrap-Around Incubator may advantageously be built by a team with proven capabilities in the development of services companies. The Incubator is a service company. The three-phase methodology is based on the following six steps which encompass a Preparation Phase, a Transition Model Organization Phase, and an Expand and Grow Phase.

The Preparation Phase is comprised of Step 1 and Step 2:

1. Determine the market and need for an Incubator. A “market” of donation-dependent organizations of a specific type should be available for the Incubator to succeed. Since the Incubator will use the Model organization to create products and services which will later be sold to transitioning organizations, the number of, or “pool”, of potential transitioning organizations (“TO's”) should be large enough to generate market returns from management consulting, marketing, operations, and sales services. Although The Wrap-Around Incubator can be used to transition any number of TO's, the pool of TO's to be transitioned by The Wrap-Around Incubator will typically be greater than 10.

For example, a suitable pool of organizations may typically each have:
a. Successful track records of selling their own services or products, using skills, talent, and business assets in their field;
b. Locations in geographic or cultural markets large enough to require an expanded list of services to serve their market potential;
c. Leadership in the organizations with recognized capabilities and effectiveness in their field;
d. Existing operations, market share, and funding from donors but not sufficient funding, revenues, or operations to be self-sustaining;
e. A history of purchasing sales services from commissioned sales people;
f. Executive Directors with influence among their peer leaders in other similar organizations; and
g. A respected trade association exists to promote Model success.

2. Select the Market and the Model Organization to transition. The Model Organization advantageously should have outstanding capabilities in its field, evidenced by successful programs, donor campaigns, and longevity. Typically, the Model Organization may be at least seven years old and have at least four years of successful operation, even if its funding is not at the level it prefers, and even if it has been growing at less than the rate at which its market justifies. The Model Organization will advantageously have a strong Director or President who has proven through innovative programs that he/she is prepared to innovate to achieve objectives. Further, the Director/President advantageously will fully ascribe to the concept of leveraging a methodology to achieve goals of self-sufficiency faster and with more success than could be achieved by “going it alone.”

In this early stage, the team for the Wrap-Around Incubator is typically small, and may be composed of a president, chief operating officer, and product marketing director. Seasoned business development, finance, and sales staff may be added as soon as the Incubator is funded in its “founder” round of funding. This “founder” investor round is used to:
a. Create the Wrap-Around Incubator's initial team of seasoned business development, finance, marketing, and sales staff with proven track record of business modification, marketing, and management consulting;
b. Establish an outsource team of specialized facilities resources, HR/Benefits, insurance, technology, and specialty partners needed for a particular market, e.g. music, medical, education;
b. Transition the Model while documenting the methodologies used;
c. Design and develop relationships with HR, finance, specialty facilities designers, and other specialists who will become outsource partners of the Incubator; and
d. Create the marketing for the Incubator, including the Incubator name, identity, web site, marketing plan, publicity campaign, association memberships, and local communications with investors and market influencers.

The Transition Model Organization Phase is typically accomplished in Step 3 and Step 4:

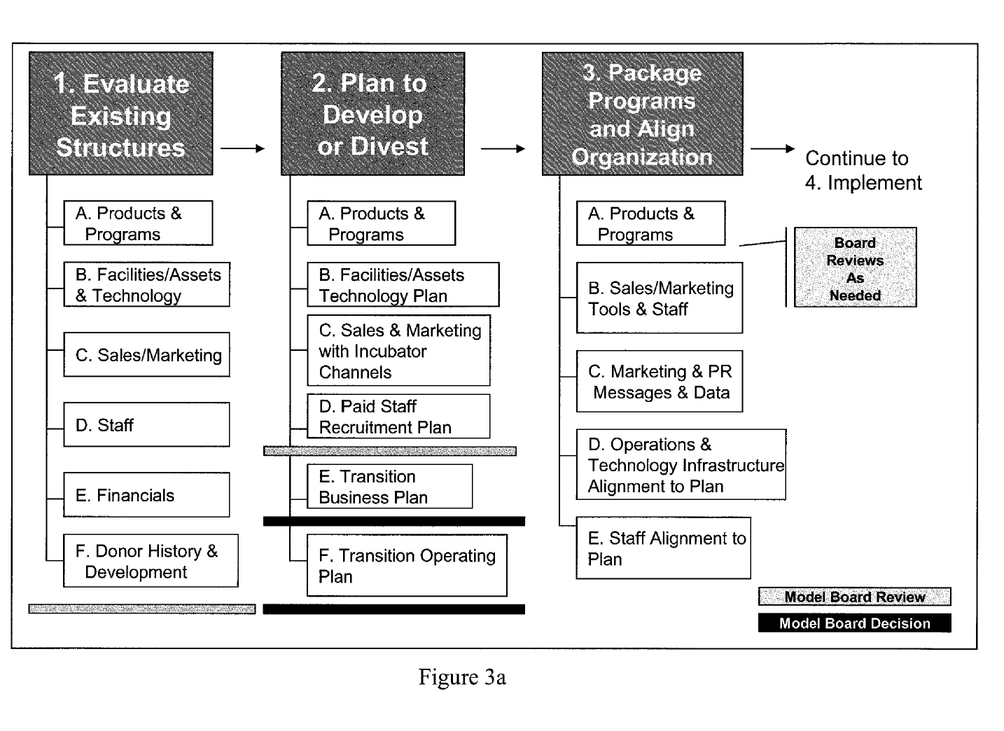

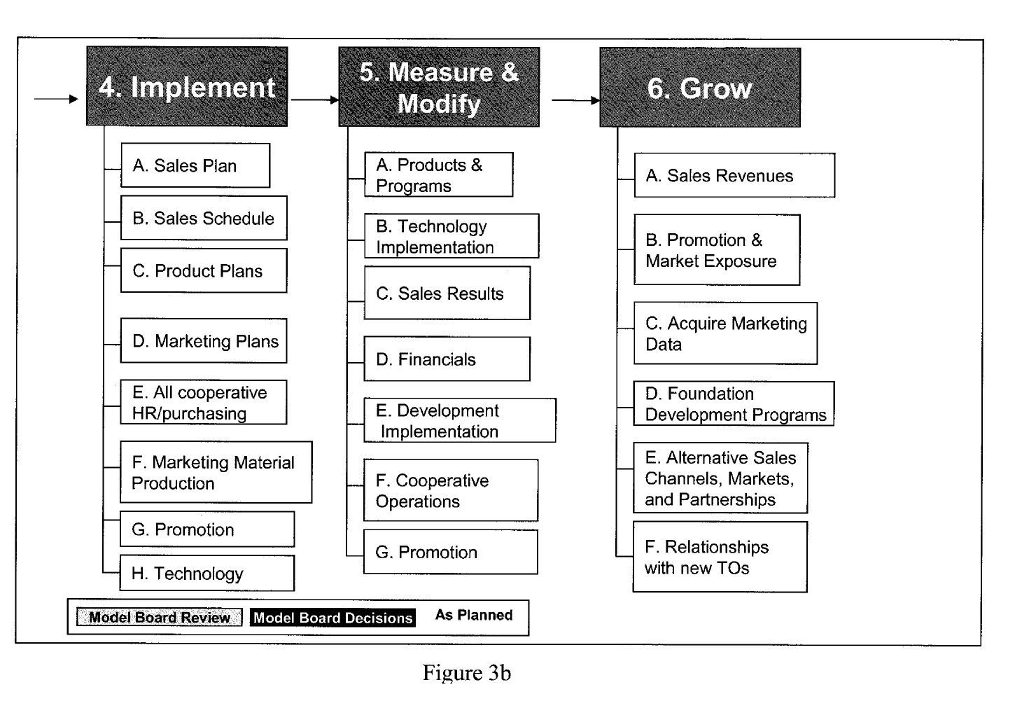

3. Build the Model Organization and the Wrap-Around Incubator Business. This is the first stage of Incubator business development and transition for the Model. One exemplary Model Transition Process (MTP) is shown in FIGS. 3a and 3b. The MTP is the first sub-process under Step 3, and can be modified for many different types of organizations. MTP Steps typically include:

1. Evaluate existing business structures of the Model organization including such structures as products and programs, sales and marketing approach and staffing, facilities, assets, and technology infrastructure and strategy, overall financials and staffing, and donor development. A review by the Model's Board of Directors follows the evaluation.

2. Plan to Develop, Divest, or Eliminate current products and programs, facilities, assets, and technology, sales and marketing structures which may be subsumed by the Incubator, and staffing. These plans are codified as a Transition Business Plan and a Transition Operating Plan. The Transition Business Plan sets business goals for the transitioned business including shifts in strategy, market reach, product offerings, facilities, donor development, and expected financial and operational outcomes of the transition. The Transition Operating Plan sets out schedules, basic operating rules for the Model and the Incubator working together, the agreed measurement methods for evaluating plan success, and the overall plan to achieve the Transition Business Plan objectives. Incubator and Model management create the Plans and Plans are approved by the Model Board of Directors.

3. The next step, Package Programs and Align Organization, is the initial activity in the Transition Operating Plan. In this step products and programs, sales and marketing tools and staff, marketing and public relations positioning, and staff are all aligned to the Business Plan. Operations which include integration with the Incubator's operations and information technology infrastructure aligns the organizations and makes possible joint sales, marketing, operations, and on-going development.

4. Implement is the step in which the Transition Operating Plan is implemented. The following are typical elements which would be implemented for most organizations.
Sales Plan
Sales Scheduling and Staff Development
Product Plans
Marketing Plans
Cooperative HR and Purchasing with Incubator partners
Marketing Material Production
Promotion
Technology
   Unique elements might be expected for organizations such as medical clinics which may require certification by government organizations.

5. Measure and Modify is the step in which Model products and programs, technology implementation, sales results, financials, cooperative operations, promotion, and cooperative operations are evaluated against Transition Business Plan objectives. These measurements take place throughout the implementation, but at a point agreed upon by the Incubator and Model management, a retreat or other such evaluation venue may be selected to evaluate success using specific measurements. These measurements may be presented by joint management team to the Model's Board of Directors. Additional modification or implementation steps may be undertaken as needed.

6. Grow is the step in which the Model is operating under the new, transitioned staff, operations, and with joint capabilities of the Incubator. Each of the elements below is typical of ones that might be a focus for growth:
Sales Revenues
Promotion and Market Exposure
Market Data Acquisition
Foundation Development Programs
Alternative Sales Channels, Markets, and Partnerships
Relationships with new TO's

As each step in the Model Transition Process is executed the Model becomes healthier as a business, the Incubator increases its understanding of what is needed by other TO's, and the Incubator's ability to grow and meet its financial objectives should be enhanced. Incubator staff may be added to the Model to create the methodologies, products and services that will be used to transition the Model. Working with the Model staff on-site, the Incubator staff may design, and re-design the Model's approach to focus on self-sufficiency. The Model may transition its HR and benefits management to an Incubator partner and reduce or re-assign in-house staff accordingly.

The Incubator may provide a level of transition funding to the Model, as a loan, to be repaid by the Model post-transition. This loan may be used by the Model to hire full-time staff, rather than focusing on volunteers, so that staff continuity and productivity can be developed and measured. For example, in the case of performance organizations, such as choruses or symphonies, the addition of full-time singers or musicians is a key element of transition. By utilizing full-time performers, the number, frequency, and type of performances can be enhanced and sales revenues increased. Further, the Incubator sales team may sell these enhanced services on a commission basis no greater than typical commissions for the market. This allows the Incubator to develop core competencies in sales which will assist all future TO's. All Incubator activities may be measured and managed to the highest standards for services companies.

The Incubator staff markets and sells services for the Model and documents each process for future use with other organizations. Peers of the Model's leaders who lead similar organizations may be invited to review progress of the Model and provide input to the Incubator and Model team. These reviewers may be invited from potential future transitioning organizations.

The Incubator Business may create milestones for the transition of the Model and refine the milestones as the Model progresses. The Incubator may add staff as needed to the sales and marketing teams. The Incubator may begin to market its transition services to the selected market, inviting peers of the Model leader to review progress. The Incubator may build or lease market-specific facilities that can, in turn, be leased to the Model and to the full-time staff of the Model who need facilities such as, for example for teaching private students, creating specialized workshops, creating recordings, or otherwise earning additional income for which they are willing to pay rent for specialized space.

4. Transition the Model and the Incubator Business. Referring back to FIG. 2, in this step, the Model sets up a related foundation to manage those products for which no revenues can be expected. This foundation remains a 501 (c) (3) organization even as the Model begins to transition to a greater and greater percentage of earned income and thus, self-sufficiency. The Model launches and the Incubator sells new products and services. The Model may execute its marketing and sales plan with the help of Incubator staff. The Model may develop a chief operating officer and begins the transition from Incubator staff to in-house staff for operations. The Model may promote its success with the Incubator team. The Model's new products and services may be marketed and sold very aggressively by the Incubator marketing and sales staff. The goal should be to double the revenues for the Model within the first 18 months after transition. The Model may establish relationships with the Incubator's outsource partners, use the Incubator's on-line and in-person sales channels, and link its technology infrastructure to the infrastructure of the Incubator. Transition is complete when the Model is able to create additional highly-marketable products, utilize the services of the Incubator sales team to sell those products, and maintain a level of self-sufficient cash flow to sustain its operations without donations. In some markets, the Transition will be longer than others because of the nature of the Model's requirements. For example, in medical markets, relationships with teams of doctors, laboratory providers, and others may require unique contracts which take time to develop for the benefit of both the providers and the Model organization.

Meanwhile, the Incubator business is on the move. Managing finances for the Model, the Incubator modifies plans and cash flows as needed. The Incubator completes facilities which may be leased or sold to the Model for market interest rates. The Incubator may package the products, services, methods, and know-how for the Model so the services can be extended to additional TO's. The Incubator's sales channels are developed and relationships with service providers and suppliers are linked to the Incubator's technology infrastructure so these capabilities can be shared with the Model and future TO's. The Incubator's information technology may be built specifically to reduce costs for the Model and future TO's by providing economies of scale not available to any individual organization.

The Incubator's sales channels may sell the Model's products aggressively in markets targeted by the Incubator and Model leadership in the plans created in Step 2. Frequent plan reviews ensure that plans are modified as needed to meet revenue and operational targets.

The Incubator may establish its list of “target” TO's which will become Members of the transitioning group that the Incubator selects. The Incubator begins marketing to this group of TO's and may aggressively sell the services and products of the Incubator. At this time, a second round of financing would typically be required to fund the growth of the Incubator staff and to expand services to new TO members.

The Expand and Grow Phase will likely utilize Steps 5 and 6, but may also include additional steps specific to the market for the member TO's. For example, selection of international members may require a domestic and separate international Step 5. Steps 5 and 6 include the following activities:

5. Expand the Incubator Business to New Expansion Member TO's. The Incubator contracts with new TO's and begins their transition following the methodologies and products/services developed for the Model. As TO's are transitioned, the Incubator should function as an on-going management, operations, and marketing services company to fully transitioned TO's, as it continues its planning and transitioning activities with new TO's. An evaluation of leases and long-term financial commitments of each new member should be undertaken, so that recommendations can define the value of using the Incubator's services and operating partners. New facilities may be built in locations convenient to the new TO's. Conversion of facilities currently belonging to the TO's may be managed by the Incubator's facility partners. The Incubator may sell services and products from supplier partners which have been tailored to the TO's' needs and may sell the TO's products and services for a commission. TO's using the educational and business development methods of the Incubator may be “certified” by the Incubator, thus identifying and branding the TO as a “self-sufficient” and “well-run business” in the field. Certified TO's may have access to special opportunities, leases, and promotion. The TO typically would convert its infrastructure for marketing and sales to the Incubator's channels including using Incubator-produced marketing materials and/or agency processes. If the TO has contracts with existing marketing providers, the transition to the Incubator's services could be made at the next contract renewal period. TO's may purchase or lease facilities developed by the Incubator.

6. Grow the Incubator Business and Help Expansion Member TO's Grow. New TO's may be assisted by the Incubator to grow revenues and free cash flow to maintain self-sufficiency. New channels of distribution or sales may be employed by the Incubator. A professional Board of Directors may be established for each TO with business professionals on the Board. The Incubator Business will grow and an extended second or third round of funding may be sought as the business grows. Market rates of return may be shared with investors as the pool of TO's grows and the fees for products, services, consulting, and facilities accrue to the Incubator. Each TO may achieve faster growth by leveraging the successes, information, and programs of fellow members. The Incubator creates liquidity for Investors by spinning off leases, selling facilities, and adding more TO's. The symbiotic relationship of the Incubator to the TO's ensures that both parties are tightly tied to the success of the other, creating mutually sustaining entities.

III. Description of Five Exemplary Linked Business Development Components that Form the Wrap-Around Incubator Company.

Five exemplary business development components which comprise the Incubator company are described below. Each of the components may be used to transition the Model organization, grow the Incubator business, and expand the Incubator's business to transition additional TO's. Once the methodologies, products, and services have been developed for the Model, the company may extend its reach to other similar transitioning organizations (TO's) for a fee. By “joining” the Incubator as a member, a TO is able to tap all the know-how, facilities, products, marketing, and sales channels that have been developed for the Model. Exemplary business components of the Incubator include:

Product Development;

Marketing;

Sales;

Operations, HR, Purchasing, Facilities; and

Funding.

1. Product Development.

Cultural organizations develop products and services (here all product and services are termed “product”) which are delivered to the constituency for which the organization was founded. The profitability of those products is not necessarily the driving force in product development for a community services or cultural organization. Every cultural organization, even when self-sufficient, will still develop services or products which cannot be self-funding and for which donations may be sought. It is the intent of The Wrap-Around Incubator to differentiate between the two kinds of products, and to develop each kind of product for maximum efficiency and effectiveness.

Sustaining Products. Sustaining Products are those which generate revenues and surpluses greater than the cost of supplying the product. The surplus funds, currently termed “related surpluses” for tax treatment can be increased at an indefinite rate or level and still receive favorable tax treatment. The first, most significant element of The Wrap-Around Incubator is to identify, develop, package, market, sell, and operate each Sustaining Product for maximum surplus income. In a traditional business, this “contribution to profit” is the key component of business health.

By creating Sustaining Products for the Model, The Wrap-Around Incubator is able to institutionalize and document the process of product creation, package the process and know-how, and transfer the resulting market-proven approach to other organizations like the Model. Sustaining products are clearly the core of current efforts by 501(c)(3) organizations. Various approaches to sharing best practices have hitherto failed to bring about the development that donation-dependent organizations need. The Wrap-Around Incubator provides product development know-how and methodologies from for-profit businesses to generate the best sustaining products for each type of Model organization.

Development Products. Development Products are those products created to expand the reach of a charitable enterprise; or to enrich, assist, educate, or inform the general public or a specific constituency of the 501(c)(3) organization, e.g. music educational programs for children, training in an emergency procedure, or programs for the poor. Most development products cannot be “sold” and many of them pass through donated funds directly to those affected. These products and services will continue to be provided by cultural and community services organizations regardless of how self-sufficient the organization becomes. Product development for the Model will make each Development Product as efficient and effective as possible—thus safeguarding and maximizing the value of every donated dollar. The creation of a related foundation into which donations and existing endowments may flow to support Development Products is a component of the transition process for organizations which may want to become profit-making, non-501(c)(3) organizations.

The Wrap-Around Incubator funds product development for the Model organization and the Incubator staff works on site to create a product development process in real time with the Model's staff. The Incubator may evaluate the percentage of the TO most likely to continue to fund Development Products vs. Sustaining Products. The optimum TO operation may be built to support the appropriate percentage, assuming that the majority of products will be Sustaining Products in the future.

The Incubator and Model product developers may use the process and design and test both Sustaining and Development Products for the Model. These products may then be marketed and sold by the Incubator on behalf of the Model.

2. Marketing.

The Incubator may develop a sales and marketing channel for the Model, so that best practices in marketing and sales can be used for the Model and for the similar TO's to which the Incubator later sells its services.

No current business design combines the concepts of a professional marketing and sales channel with product development, finance, and related facilities for use by related donation-dependent organizations to generate surplus funds. The Wrap-Around Incubator performs these functions in a uniquely efficient way—the functions are tailored to the purposes of the Model and other organizations like the Model.

All marketing functions may be developed at the Incubator for fee-based services and products. The Incubator makes these tailored services available to the Model for either no fees or discounted fees in return for Model testing and assistance in content expertise for service development.

Marketing Organizations. The Incubator may create a marketing organization for the Model and a reciprocal marketing operation within the Incubator. The Model's marketing organization is essentially a project marketing support function with a paid part-time or full-time marketing manager who will utilize the marketing materials and products developed by the Incubator.

The Incubator's marketing organization is a marketing service group developing first Model-specific, then TO-specific marketing materials and products that can be easily tailored for specific TO-use, packaging the materials and products, creating training and education in how to execute the products for TO marketing staff, establishing measurements for marketing effectiveness and project management tools for efficiency. When packaged, these marketing materials are branded appropriately for the type of organization.

A TO's existing marketing organization may be larger or smaller than the Model organization's staff. If a larger organization with paid staff is in place, the TO will tailor its own subscription materials but will still pay the subscriptions fees for materials and services.

Marketing Services. Tailored marketing materials and services are sold to TO's by monthly subscription plus initial marketing consultation and operational consulting fees which generate a revenue flow for the Incubator.

TO benefits include significant faster time to revenues, quicker launch of new marketing initiatives, quality consistency, and lower cost of marketing staffing and ancillary services. The TO is likely to have outsourced significant marketing functions in the past, to various marketing support organizations and may have paid a greater amount of money for those services than they will pay the Incubator for the same services because they can leverage the work done for all TO's and for the Model, thus reducing each TO's overall cost of marketing services.

By converting the marketing function to a profit-oriented approach, the TO begins its drive to higher surplus funds very quickly using a proven approach attractive to donors and other supporters.

Certification Brand. Once a TO is actively using the Incubator's full complement of marketing, sales, and support services, the TO may be branded as a “certified” organization, indicating that the best business practices are being used by their organization. The Incubator may heavily market the Certified brand, giving the TO another reason to leverage the Incubator's services. The Certified brand may soon create its own momentum for other TO's to join the group and to market to their donors and the public that they are Certified, thus providing the best possible return to donors and the public on any dollars donated or spent with the TO.

3. Sales.

The Incubator's sales organization may be a professional sales staff, paid by an initial set-up fee and commissions from the TO. The Model may not pay a set-up fee, and may pay reduced commissions as the Incubator develops the sales process, methodology, tools, technology, and staff for the Incubator to use in the future. A TO may currently pay a development director and staff to sell to donors and a separate staff or sales service company to sell to the public and other constituencies. The Incubator's staff may take over the “market to the public and constituencies” functions for TO's so they can focus their attention on program development and execution.

The Incubator sets up a sales organization made up of skilled, experienced sales people who currently sell products and services in profit-making ventures which may be related to the Model's market, for example, ticket, recording, and event sales people accustomed to selling for profit-making organizations in music and the arts. These experienced staff may immediately begin focusing on the Model, driving new revenues, making new contacts, and establishing new constituencies for the Model's products. This sales organization may be run to meet profit-making objectives and may deliver to revenue targets for the Incubator. The sales people may report to management in the Incubator and the Model and TO's are the suppliers of products that they sell.

By outsourcing sales, the TO's achieve two unique benefits. First, they can concentrate more of their resources on developing unique, sellable programs, and place more staff in program execution roles. Second, they can devote more attention to Development Products, the donors who support them, and the staff that delivers them. Sales management is difficult. Many TO's cannot attract or keep professional quality sales people because the pay levels, challenge, and future return is too low to interest professionals. The Incubator may attract those types of people in each market because the management of the Incubator is focused on profitability and the salesperson's individual pay-off is potentially above market levels.

4. Operations, HR, Purchasing, and Facilities.

The Incubator evaluates and establishes optimum operations for the Model and translates those best practices to additional TO's. The ideology of donor-dependency results in a donor-development-centric organization and operational focus. The goal of Incubator operations is to create operational infrastructure focused on transitioning organizations and delivering the revenue-generating services for which TO's will pay the Incubator.

The Incubator's Operations team focuses on supporting infrastructure, marketing/sales services, facilities development and management, and HR and purchasing. Each Incubator built on the Wrap-Around Incubator design may establish internal operations focused on streamlined management, and may engage partners or affiliated companies to deliver specific services to TO's.

Human Resources Services. Services may be contracted by the Incubator for all TO's selected by the Incubator for transition. This combined HR contract may offer TO's economies of scale over individual HR contracts created by each TO. Benefits services, HR payment services, a job bank, and other HR services may be maintained by, or contracted by, the Incubator.

Specialized Facilities. For some markets, the Incubator may become the builder and source of specialized facilities for TO's. The Incubator can create and manage specialized facilities to be rented or sold to TO's, thus generating revenues for the Incubator and unlocking trapped capital for TO's. The Incubator may determine the value of providing those specialized facilities to their target TO's in large markets. In some cases, the Incubator will build the specialized facilities and sell them to one or more TO's in the market for a market-rate mortgage. In other cases, the Incubator will hold the asset and lease facilities for market rates to the TO's, allowing the TO's to sell aging facilities, unlock capital, and use the cash for creating new Sustaining Products, payments to the Incubator for services, and potential expansion to new markets.

The Operations staff of the Incubator may include at least one person who is an expert in the real estate/facilities needed by target TO's. During the development of the Model, this expert may determine the exact facilities requirements for the Model, and may extrapolate a business plan for the Incubator that defines the build-out of specialized facilities and a projection of profit to the Incubator from creation of facilities for rent or sale in the top 10 TO markets.

Incubator investors may decide whether to open a round of funding to create facilities for their target TO's. In the event the Incubator chooses not to rent or buy specialized facilities, the detailed facilities build-out and plan may become part of the Incubator's specialized consulting portfolio and the Incubator will assist TO's to maximize facilities in return for consultation fees.

Co-operative Purchasing. The Incubator negotiates best cooperative prices for commodities used by transitioning TO's, so that everything from janitorial supplies to concert grand pianos can be purchased as a buying group, thus leveraging the value of each TO's certification. The Incubator may not act as buying agent, but may maintain relationships with all companies offering discounts, thus maintaining an active list of cooperative partners who guarantee best prices to the TO's the Incubator is transitioning. Each TO may pay an annual purchasing management fee to the Incubator, but pays its own bills for commodities. The annual discount contracts, relationships, and their renewals may be managed by Incubator Operations in return for the cumulative management fees from all TO's.

5. Finance.

Incubator finance is organized to maintain its internal investment and operational requirements, including all necessary legal and financial requirements to maintain its financial reporting and investment status. Because The Wrap-Around Incubator has complete control over the rate of expansion and breadth of geographic scope of its business, the Incubator can build its plans for rapid or sedate growth, depending on the investment objectives of its investors. Selection criteria for future TO's may be developed for maximum return and lowest possible risk to achieve that return. The executive team of the Incubator may establish the criteria as they build the Model's best practices and evaluate the Model's market for weaknesses and strengths.

Financial Products. The Incubator may also undertake the development of financial products in addition to the purchasing and specialized facilities products defined above. Start-up or transitioning financing may be of interest to investors for a given TO marketplace where opportunities abound. The Model is the basis for the development of these services and, during Model development, financing services may be created. These may either be offered to the TO directly by the Incubator, or the Incubator may contract with a financial management organization to provide such services to the TO's for a fee. The Wrap-Around Incubator reduces risk for the formation of specialized financial services because all such services are tested and proven in the Model prior to offering them to the wider TO group. The Incubator investors thus have a “dry run” on every service, reducing the risk and maximizing opportunity for return.

IV. Specialized Transition Services.

The Wrap-Around Incubator is efficient. The Wrap-Around Incubator may also provide the following Specialized Transition Services. The differences between traditional business services and those provided by The Wrap-Around Incubator are described below:

1. Business Incubator Services.

A typical business Incubator is a funding and management-centric joint venture model allowing companies to share resources, acquire venture funding, and gain management support in early stage development. Generally a single location with venture or local business development backing, the Incubator provides only a portion of the value needed to transition a donation-dependent company to independence.

A new model is needed to transition organizations which have historically relied on non-profit management, funding, and ideology. The Wrap-Around Incubator combines this concept with all the other elements needed to create independent, profit-oriented organizations.

The outcome of the full-service Wrap-Around Incubator is business effectiveness by creating, first from its Model company, and later from others of the same type, profit-making entities which deliver a market rate of return to investors. Unlike pure venture models, the Wrap-Around Incubator does not take chances on multiple unproven business concepts, hoping to deliver returns from at least a few of them. The Wrap-Around Incubator instead may select proven cultural and community services organizations which need to change the orientation of their management, the sources of their funding, establish products of value, and deliver that value in perpetuity. The Wrap-Around Incubator is thus able to hedge against market and financial risk by selecting organizations most likely to make the to-profit transition that the investors want to promulgate.

The Wrap-Around Incubator may be applied to a single large transitioning organization, acting as a Model, provided that the single organization is diversified, has a national or international reputation, offers many useful Sustaining Products in its current portfolio, and actively is seeking to transition to more surplus revenues. The return from The Wrap-Around Incubator applied in this way is more likely to be focused on rapid re-deployment of the Model's resources and staff, relying on the Incubator as a services company, and unlocking trapped capital in aging or under-utilized facilities. All the aspects of the Incubator can be applied in this single-Model function, but the investors should not expect rates of return as large as those for a more widely distributed, multi-TO application.

2. Marketing and Sales Services.

A traditional marketing services company is an organization which provides marketing and sales support services to companies for a fee, sometimes providing packaged services for groups of companies with similar objectives, but most often providing client-specific services for a variety of companies.

The services and consulting from the Wrap-Around Incubator are based on the development of a Best Transition Model (Model) for each type of organization, e.g. choral group, symphony, art museum, medical clinic. The Incubator then uses the services and methodologies created for the Model to transition multiple additional organizations of the same type. The services may then be packaged by the Incubator and offered for a fee.

Combining services for various donation-dependent organizations into the Wrap-Around Incubator allows these organizations to leverage the cost of such services, while elevating their capabilities to profit-making levels. Using proven Transition Services provides the best thinking, management, and methods at the lowest possible cost eliminating the need for costly changes in staff as an organization modifies its approach to the market. The Wrap-Around Incubator receives funding from ongoing services sales and subscriptions required of each of the organizations selected for the Incubator.

3. Marketing, Management, and Sales Consulting.

A typical consulting company provides expertise and planning in market research, marketing operations, sales channel development, and direct sales operations to a variety of organizations or to companies having similar business models, for a fee.

The Wrap-Around Incubator may provide specific forms of marketing, management, and sales consultation services, proven in the real world by the Model organization, and leveraged by many organizations. The Model-based methodology, tailored for local requirements, reduces costs for transitioning organizations. This specialized on-site consultation supports a donation-dependent firm as the team quickly ramps management, aligns priorities with operations, and synchronizes resources using proven approaches. The Wrap-Around Incubator may receive income from initial and on-going development and sales consultation.

4. Financial and Employee Services.

The Wrap-Around Incubator may provide benefit services, operating loans, and insurance services. The Incubator may eliminate the operational ramp needed to acquire paid employees where volunteers have been the predominant resource. Organizations making the transition to profit need the back-up of a benefits, tax, and financial management firm.

Loans at market rates provide interest income to the Incubator, and support ramp funding for transitioning organizations which meet the Wrap-Around Incubator's criteria. Benefits services are provided for a fee to each transitioning organization.

5. Specialty Facilities Services.

The Wrap Around Incubator builds and leases professional facilities for transitioning organizations such as musicians, artists, curators and restorers, clinics, which have opportunities to generate income from unique facilities, such as studios. In large market cities the Wrap-Around Incubator may jump start the profitability of organizations by underwriting the initial construction of such specialized facilities as studios, rehearsal halls, and even clinics.

Leasing or selling the facilities with a traditional mortgage held by the Incubator creates on-going cash for the Incubator. This approach limits heavy initial investment for facilities at the local level. The specialty facilities can be sold to local organizations at any time during the mortgage period.

V. Benefits to Transitioning Organizations Translate into Revenues for the Wrap-Around Incubator

Transitioning Organizations could expect to receive a number of quantifiable business benefits by working with a Wrap-Around Incubator. These benefits might include:
Faster time to higher revenue
Broader market penetration
More creative or better executed products and programs
More efficient use of donor funds
Lower cost of operations through economies of scale through shared infrastructure with Incubator and other TO's including reduced staff costs
More varied benefits for staff
Rents, facilities management fees, mortgages paid to Incubator may convert locked-up capital to cash, while achieving newer or better facilities and receiving revenues from facilities use
Management expertise not available through current sources

The Wrap-Around Incubator may receive benefits including enhanced capabilities to add market reach and on-going revenues from the Model and other TO members for services such as:
Monthly subscription fees for marketing materials and services tailored for use by TO's
Commissions for sales of TO products and services; multiple sales channels should be anticipated for most transitioned organizations including both in-person and online sales
Fees from suppliers and partners who use an Incubator's internal member channel to sell services and products to TO's
Fees from facilities management, rents, and mortgages for facilities
Market rates of interest for TO loans
Management consulting fees

In both cases, the symbiotic relationship between the Incubator and member TO's continues to provide benefits to each organization. The long-established maxim “we get rich if you get rich” exemplifies the desired results of a Wrap-Around Incubator. Each TO gets richer and, as they do, the Wrap-Around Incubator may produce greater profits and returns for its investors.

VI. Results: Unique Lone-Term Investment Opportunities for Investors and Self-Sufficient Cultural, Arts, Medical, and Community Organizations.

The Wrap-Around Incubator is a needed business design because it provides value for a non-profit organization constituency which has long provided cultural and other services of value to our communities, and our country.

The Wrap-Around Incubator attracts investors, however, because of the healthy return on investment made possible by the generation and maintenance of new capital and revenue formation from these donor and grant dependent organizations. Expectations are for returns from 19% to 30% on original investments once the Model is transitioned and expansion begins. At the same time, investors in the Incubator provide valuable support for organizations that might otherwise shrink or die, thereby seriously damaging culture, health, or welfare.

Each set of transition services is profitable not only for the local organizations which transition to self-sufficiency, but also to the investors who have placed at risk the funds to fuel the transition.

In short, the results may include: (a) healthy cultural, health, arts, and welfare organizations, able to serve their functions without fear that their mission will be impaired by lack of funds, (b) Incubator businesses capable of creating and executing transition strategies and operations for a profit, and (c) investors who make at or greater than market rates of return. The efficiency and effectiveness of this business design is clear and the leadership for its launch rests with the developers of this patent application.

### EXAMPLES

The following are non-limiting prophetic Examples illustrating application of The Wrap-Around Incubator to exemplary organizations for transitioning the organizations from grant and donation-dependent organizations to self-sufficient enterprises.

### Example 1

### Application of the Present Method to a Chorus

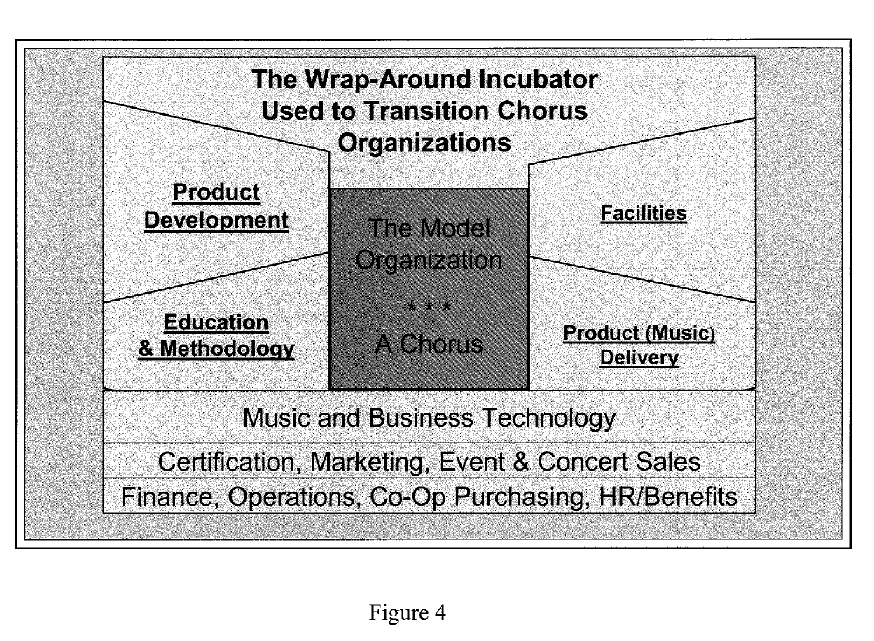

Referring to FIG. 4, an exemplary application of the Wrap-Around Incubator to a Model organization in the form of a 501(c)(3) chorus is illustrated in connection with the description above. In this example, the chorus wishes to become self-sufficient, no longer relying primarily on donor and grant funding. The chorus wants to continue to provide services to the community which it serves, and to expand its services to a broader market that can fund its growth and help make the organization self-sustaining in the future.

The Incubator would execute all the steps described above in the Development of a Wrap-Around Incubator and the Model Transition Process (MTP). The application of the Wrap-Around Incubator could be tailored to the Chorus market as the Model is transitioned in the MTP as follows:

Product Development for the Chorus
Needed services to expand the Model's market penetration might include definition of the most-desired chorus products to meet the needs of particular market segments by age, music preference, season of the year, region of the country, or performance criteria
The pace and variety of product development and specific products to be developed during the transition and later
Pricing and packaging for the products
Joint product planning for growth with shared expertise from the Incubator and Chorus management
Packaging of the methodology used for Chorus Model transition so it can be used effectively by the Incubator for other choruses

Education/Methodology to be Used by the Chorus on a Regular Basis
Voice education and training curricula and approach
Community education programs
Chorus Management
Chorus Member Development
Curricula and Teachers

Facilities Needed to Complete Various Aspects of Chorus Operations
Performance
Practice
Rehearsal
Education and Training

Product (Music) Delivery
Concert and Event Scheduling and Management
Music Publishing
Studio Equipment and Use
Video and Audio Recording and Pod-casting
Studio Management

Music and Business Technology
Linked technologies between the Chorus organization and the Incubator provide for joint sales of events, and scheduling of those events, ticket sales, and financial transactions and reconciliation
Business technology includes shared information technology infrastructure, internet hosting, music delivery infrastructure (marketing standards and production, pod-casting, video production and sales, and shared calendar and email)

Certification, Marketing, Event and Concert Sales
Branding of the Model
Marketing agency infrastructure for advertising, promotion, and public relations
Concert sales through three Incubator-owned sales channels

Finance, Operations, Co-operative Purchasing, Human Resources/Benefits
Shared software for operations
Relationships with Incubator partners to outsource human resources and benefits management
Cooperative purchasing with other TO's of such items as costumes, apparel, stage equipment, pianos, studio equipment, instruments, and tools
A specialized voice teaching studio, music library, and recording studio owned by the Incubator, but leased to the Chorus

### Example 2

### Application of the Present Method to a Community Clinic

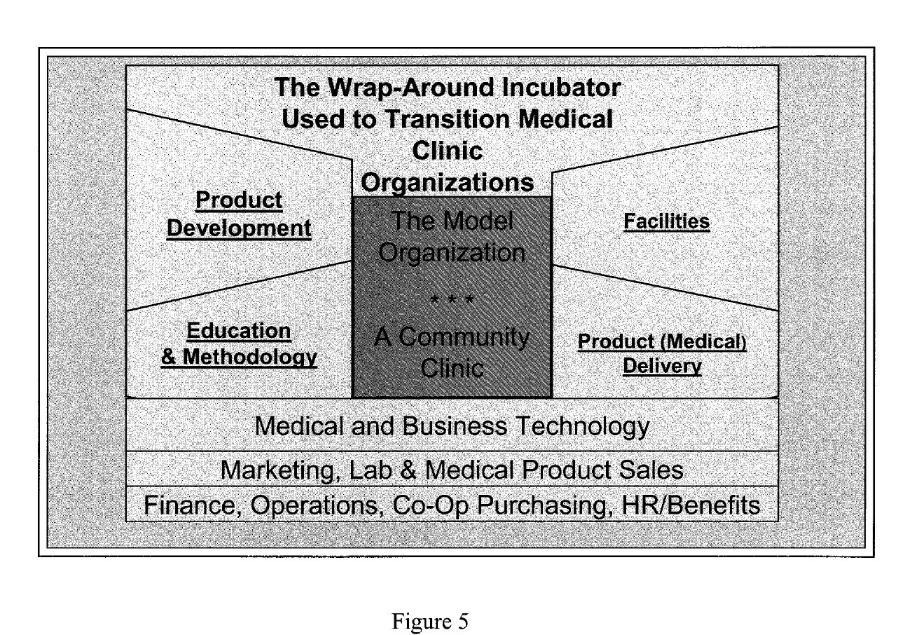

Referring to FIG. 5, an exemplary application of the Wrap-Around Incubator to a Model organization in the form of a community medical clinic is illustrated in connection with the description above.

The Incubator would execute all the steps described above in the Development of a Wrap-Around Incubator and the Model Transition Process (MTP). The application of the Wrap-Around Incubator could be tailored to the medical market as the Model is transitioned in the MTP as follows:

Product Development for the Community Clinic
Needed services to expand the Model's market penetration might include definition of the most-needed medical diagnosis, management, and delivery products to meet the needs of particular market segments by age, ethnography, season of the year, language, region of the country, international travelers, addictions, or other factors
The pace and variety of product development and specific products to be developed during the transition and later
Pricing and packaging for the medical and lab products especially between insurance-supported, fee-based, and free services
Joint product planning for growth with shared expertise from the Incubator and medical management should include a partnership with a local group of doctors and nurses in the specialties the clinic expects to deliver
Licensing and regulation requirements
Packaging of the methodology used for Clinic Model transition so it can be used effectively by the Incubator for other clinics

Education/Methodology to be Used by the Clinic on a Regular Basis
Education and training products
Community education programs
Clinic Management
Clinic Staff Development
Clinic Partnerships for client education
12-step program partnerships

Facilities Needed to Complete Various Aspects of Clinic Operations
Business Offices
Examination Rooms
Laboratory services and/or facilities
Medical Offices
Hospital partnership(s)

Product (Medical) Delivery
Outpatient
Hospital
Neighborhood
Pharmacy

Medical and Business Technology shared by the Incubator and the Clinic would include security services, shared business office technology, HIPAA-compliant medical records, diagnostic tools, diagnostic and procedure librarian with linkage to medical or nursing library, and insurance claims processing

Marketing, Product Sales might include joint grant development, marketing, promotion, market research, clinical research studies, and medical information and education events for TO staffs.

Finance, Operations, Co-operative Purchasing, Human Resources/Benefits all might conform to the same types of operational leverage provided to any other implementation of the Model, but certainly should include shared laboratory services developed under a partnership agreement.

### Example 3

### Application of the Present Method to a Literacy Program Provider

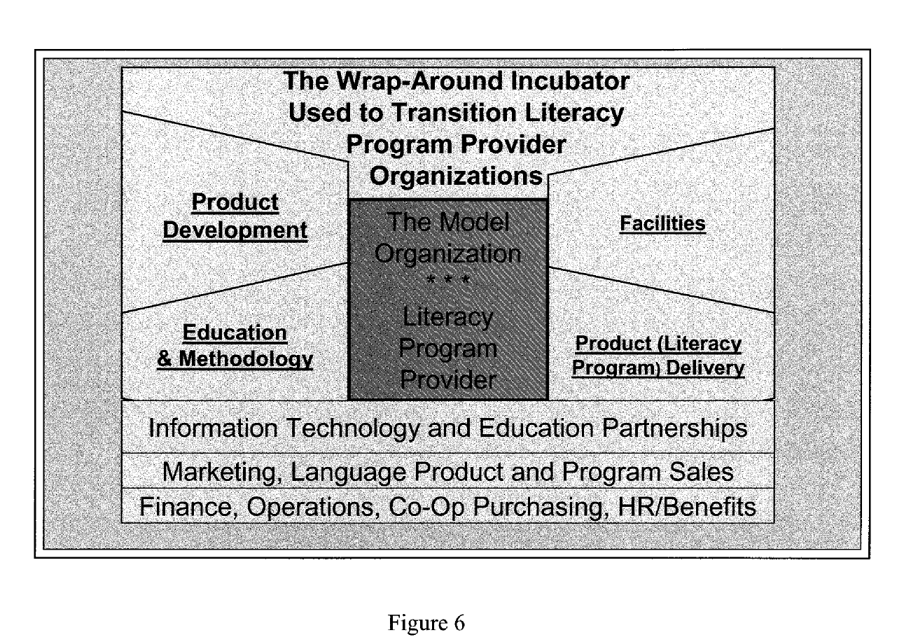

Referring to FIG. 6, an exemplary application of the Wrap-Around Incubator to a Model organization in the form of a literacy program provider is illustrated in connection with the description above.

The Incubator would execute all the steps described above in the Development of a Wrap-Around Incubator and the Model Transition Process (MTP). The application of the Wrap-Around Incubator could be tailored to the fee-based and non-profit literacy program market as the Model is transitioned in the MTP as follows:

Product Development for the Literacy Program Provider
Needed services to expand the Model's market penetration might include definition of the most-desired literacy education and support products to meet the needs of particular market segments by age, ethnicity, country of origin, international business, international and US remedial education, prison re-entry, GED requirement, and local business reading performance criteria
The pace and variety of product development and specific products to be developed during the transition and later
Pricing and packaging for the products
Joint product planning for growth with shared expertise from the Incubator and Literacy management
Packaging of the methodology used for Literacy Program Provider transition so it can be used effectively by the Incubator for other organizations, which would be especially relevant if government assistance is required to meet local or state regulations

Education/Methodology to be Used by the Provider on a Regular Basis
Streamlined design for education and training curricula and approach
Community education and awareness programs
Community Partnerships
Special educational methods to meet product development requirements
Curricula and Teachers

Facilities Needed to Complete Various Aspects of Literacy Program Provider Operations
Business Office and Evaluation
Classrooms
Corrections Facilities Classrooms and Procedures (Prisons)
School

Product (Literacy) Delivery
After School Programs
Prison, Adult and Juvenile Programs
Media Publishing and Delivery
Remedial Literacy Delivery
Business-supported Literacy Programs

Information Technology and Education Partnerships developed for specific program requirements, especially shared media, materials, curricula, case management approaches, evaluation methodologies and results testing

Marketing, Language Product and Program Sales developed for specific program requirements

Finance, Operations, Co-operative Purchasing, Human Resources/Benefits similar to those for any other implementation of the Wrap-Around Incubator

### Example 4

### Application of the Present Method to a Regional Symphony

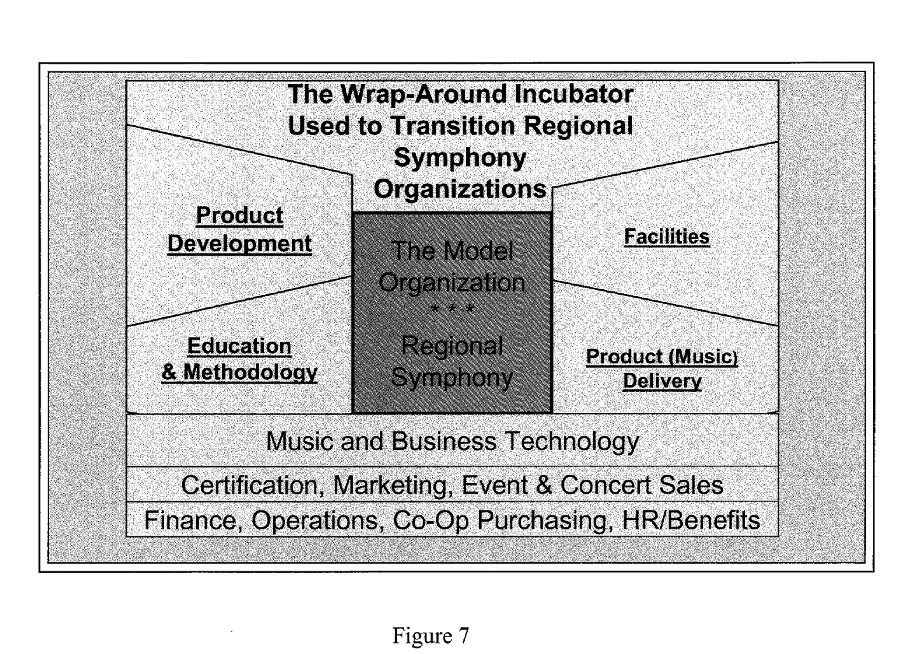

Referring to FIG. 7, an exemplary application of the Wrap-Around Incubator to a Model organization in the form of a regional symphony is illustrated in connection with the description above.

The Incubator would execute all the steps described above in the Development of a Wrap-Around Incubator and the Model Transition Process (MTP). The application of the Wrap-Around Incubator could be tailored to the Symphony market as the Model is transitioned in the MTP as follows:

Product Development for the Symphony
Needed services to expand the Model's market penetration might include definition of the most-desired symphonic products to meet the needs of particular market segments by age, music preference, season of the year, region of the country, or performance criteria
The pace and variety of product development and specific products to be developed during the transition and later
Pricing and packaging for the products
Joint product planning for growth with shared expertise from the Incubator and Symphony management
Packaging of the methodology used for Regional Symphony Model transition so it can be used effectively by the Incubator for other regional symphonies

Education/Methodology to be Used by the Symphony on a Regular Basis
Instrument, including members, contract, and youth performers
Students of musician members of the symphony
Symphony Management
Local Musician Development

Facilities Needed to Complete Various Aspects of Symphomy Operations
Performance Hall
Practice Studios
Rehearsal
Education and Training

Product (Music) Delivery
Concert and Event Scheduling and Management
Music Publishing
Studio Equipment and Use
Video and Audio Recording and Pod-casting
Studio Management

Music and Business Technology includes all elements needed for Choruses plus drayage, labor relations, transportation, and all aspects of labor management.

Certification, Marketing, Event and Concert Sales might be similar to Chorus Model development except that Symphonies have unique transportation requirements and contract personnel requirements which must be accommodated.

Finance, Operations, Co-operative Purchasing, Human Resources/Benefits should include a significant review of the facilities of the symphony as related to trapped capital, and the development of multi-symphony infrastructure for purchasing, operations, and HR.

While the present method or business design has been described as having a preferred design, the Wrap-Around Incubator can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of transitioning a plurality of grant and/or donation-dependent organizations to self-sufficient enterprises, comprising the steps of:
determining a group of grant and/or donation-dependent organizations in a substantially common field;
selecting a model organization from the group;
developing an incubator business for transitioning the model organization;
transitioning the model organization, using the incubator business, to a self-sufficient enterprise;
transitioning at least one other organization in the group, using the incubator business, to a self-sufficient enterprise.

2. The method of claim 1, wherein said first transitioning step further comprises the incubator business performing for the model organization at least one business development component selected from the group consisting of product development, marketing, sales, operations, human resources, purchasing, facilities maintenance, and funding.

3. The method of claim 1, wherein said first transitioning step further comprises the incubator business performing product development services for the model organization, including development of at least one of sustaining products and development products.

4. The method of claim 1, wherein said first transitioning step further comprises the Incubator business performing marketing services for the model organization, including at least one of:
creating a marketing organization;
preparing tailored marketing materials; and
certifying the model organization.

5. The method of claim 1, wherein said developing step further comprises the incubator business developing at least one specialized transition service for the model organization.

6. The method of claim 5, wherein the specialized transition services are selected from the group consisting of business Incubator services, marketing services, sales services, management services, sales consulting services, financial services, employee services, and facilities services.

7. The method of claim 1, wherein at least one of the donation-dependent organizations of said determining step is a Title 26, U.S.C. §501(c)(3) organization.

8. The method of claim 1, wherein said developing step further comprises organizing the incubator business as an entity selected from the group consisting of a limited liability company, a limited liability partnership, and a corporation.

9. The method of claim 1, wherein the field of the group of grant and/or donation-dependent organizations in said determining step is selected from the group consisting of:
arts organizations, including museums, arts education organizations, and artist cooperatives;
music organizations, including regional and city symphony orchestras and choruses;
medical services providers, including community medical clinics, rehabilitation clinics, and preventive care clinics;
relief organization, including food banks, emergency relief organizations, and specialty care organizations; and
zoos and nature preservation organizations.
